(19) United States
(12) Patent Application Publication
(10) Pub. No.: US 2022/0375016 A1
(43) Pub. Date: Nov. 24, 2022

(54) Exam Evaluator Performance Evaluation

(71) Applicant: International Business Machines Corporation, Armonk, NY (US)

(72) Inventors: VIKAS KUMAR MANORIA, BENGALURU (IN); Prasad Velagapudi, VISAKHAPATNAM (IN); Rameshchand Yadav, BENGALURU (IN); SATISH SOMANNA NARASIMHA, BENGALURU (IN)

(21) Appl. No.: 17/302,999

(22) Filed: May 18, 2021

(51) Int. Cl. G06Q 50/20; G09B 7/02

(52) U.S. Cl. CPC G06Q 50/205; G09B 7/02

(57) ABSTRACT

Evaluating examination scoring performance of exam evaluators is provided. Simulated examination sheets are generated that include new answer versions corresponding to examination questions regarding a particular subject matter for scoring by an exam evaluator. Each new answer version is generated based on a selected answer type comprised of a plurality of levels of a plurality of answer generating factors. A score is generated for each respective new answer version based on manipulation of model answers to the examination questions. An exam evaluation model of the exam evaluator scoring the new answer versions to the examination questions on the simulated examination sheets is formulated based on detected scoring deviations between computer-generated scores and evaluator-assigned scores for the new answer versions. Scores assigned by the exam evaluator to answers provided by a group of examinees to questions on the particular subject matter are adjusted based on the detected scoring deviations.

### BACKGROUND

### 1. Field

The disclosure relates generally to exam evaluations and more specifically to measuring an ability of an exam evaluator to evaluate and score answers provided by examinees to questions on examination sheets regarding a particular examination subject.

### 2. Description of the Related Art

Currently, the most common way to evaluate a student is using an exam. An exam is an educational assessment intended to measure an examinee's level of knowledge regarding certain subject matter. A good evaluation or assessment of an exam focuses on identifying the current knowledge level of the examinee. Therefore, an exam evaluation can be a powerful tool for an examinee's learning processes when the exam evaluation is performed properly.

### SUMMARY

According to one illustrative embodiment, a computer-implemented method for evaluating examination scoring performance of exam evaluators is provided. A computer generates simulated examination sheets that include new answer versions corresponding to a plurality of examination questions regarding a particular subject matter for evaluation and scoring by an exam evaluator. Each new answer version of a corresponding provided model answer to a particular examination question is generated based on a selected answer type comprised of a plurality of levels of a plurality of answer generating factors. The computer generates a score for each respective new answer version included in the simulated examination sheets based on manipulation of model answers to the plurality of examination questions by an artificial intelligence component of the computer trained on the particular subject matter to generate the new answer versions that provide a plurality of target score categories and respective answer types. The computer formulates an exam evaluation model of the exam evaluator scoring the new answer versions to the plurality of examination questions on the simulated examination sheets for the particular subject matter based on detected scoring deviations between computer-generated scores and evaluator-assigned scores for the new answer versions. The computer adjusts scores assigned by the exam evaluator to answers provided by a group of examinees to questions on the particular subject matter based on the detected scoring deviations in the exam evaluation model of the exam evaluator to form final answer scores for the group of examinees. According to other illustrative embodiments, a computer system and computer program product for evaluating examination scoring performance of exam evaluators are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of an evaluate the exam evaluator component in accordance with an illustrative embodiment;

FIG. 4 is a diagram illustrating an example of a table of answer generating factors with corresponding levels in accordance with an illustrative embodiment;

FIG. 5 is a diagram illustrating an example of a table of answer types in accordance with an illustrative embodiment;

FIG. 6 is a diagram illustrating an example of a table of target score categories and aligned answer types in accordance with an illustrative embodiment;

FIG. 7 is a diagram illustrating an example of an exam evaluation model in accordance with an illustrative embodiment;

FIG. 8 is a diagram illustrating an example of a table of score deviations in accordance with an illustrative embodiment;

FIG. 9 is a diagram illustrating an example of a table for exam evaluation model formulation in accordance with an illustrative embodiment;

FIG. 10 is a flowchart illustrating a process for formulating an exam evaluation model corresponding to an exam evaluator in accordance with an illustrative embodiment; and

FIGS. 11A-11C are a flowchart illustrating a process for evaluating examination scoring performance of an exam evaluator in accordance with an illustrative embodiment.

### DETAILED DESCRIPTION

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

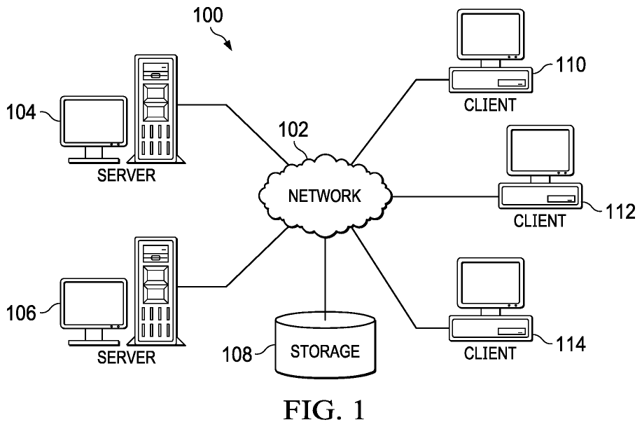

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. In addition, server 104 and server 106 provide exam evaluator performance evaluation services. Server 104 and server 106 provide the exam evaluator performance evaluation services by measuring an ability of exam evaluators to evaluate and score answers provided by examinees to questions on examination sheets regarding a plurality of different examination subjects. Also, it should be noted that server 104 and server 106 may each represent a cluster of servers in one or more data centers. Alternatively, server 104 and server 106 may each represent multiple computing nodes in one or more cloud environments.

Client 110, client 112, and client 114 also connect to network 102. Clients 110, 112, and 114 are clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, laptop computers, handheld computers, smart phones, smart televisions, and the like, with wire or wireless communication links to network 102. Users of clients 110, 112, and 114 may utilize clients 110, 112, and 114 to access and utilize the services provided by server 104 and server 106. For example, an exam administrator may utilize client 110 to input different configurations, such as, for example, answer generating factors, target score categories, and the like, into server 104 and server 106. An exam maker may utilize client 112 to input a set of question sheets regarding a particular examination subject and a set of corresponding model answer sheets into server 104 and server 106. An exam evaluator may utilize client 114 to receive simulated examination sheets with mock answers from server 104 or server 106 for evaluation and scoring of the mock answers. Afterward, the exam evaluator utilizes client 114 to send the exam evaluator's assigned answer scores and remarks to the mock answers on the simulated examination sheets back to server 104 or server 106 for assessment and identification of scoring deviations made by the exam evaluator regarding the assigned scores and remarks.

Storage 108 is a network storage device capable of storing any type of data in a structured format or an unstructured format. In addition, storage 108 may represent a plurality of network storage devices. Further, storage 108 may store identifiers and network addresses for a plurality of client devices, identifiers for a plurality of client device users, questions, model answers, simulated examination sheets, and the like. Furthermore, storage 108 may store other types of data, such as authentication or credential data that may include usernames and passwords associated with client device users, for example.

In addition, it should be noted that network data processing system 100 may include any number of additional servers, clients, storage devices, and other devices not shown. Program code located in network data processing system 100 may be stored on a computer-readable storage medium or a set of computer-readable storage media and downloaded to a computer or other data processing device for use. For example, program code may be stored on a computer-readable storage medium on server 104 and downloaded to client 110 over network 102 for use on client 110.

In the depicted example, network data processing system 100 may be implemented as a number of different types of communication networks, such as, for example, an internet, an intranet, a wide area network (WAN), a local area network (LAN), a telecommunications network, or any combination thereof. FIG. 1 is intended as an example only, and not as an architectural limitation for the different illustrative embodiments.

As used herein, when used with reference to items, “a number of” means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

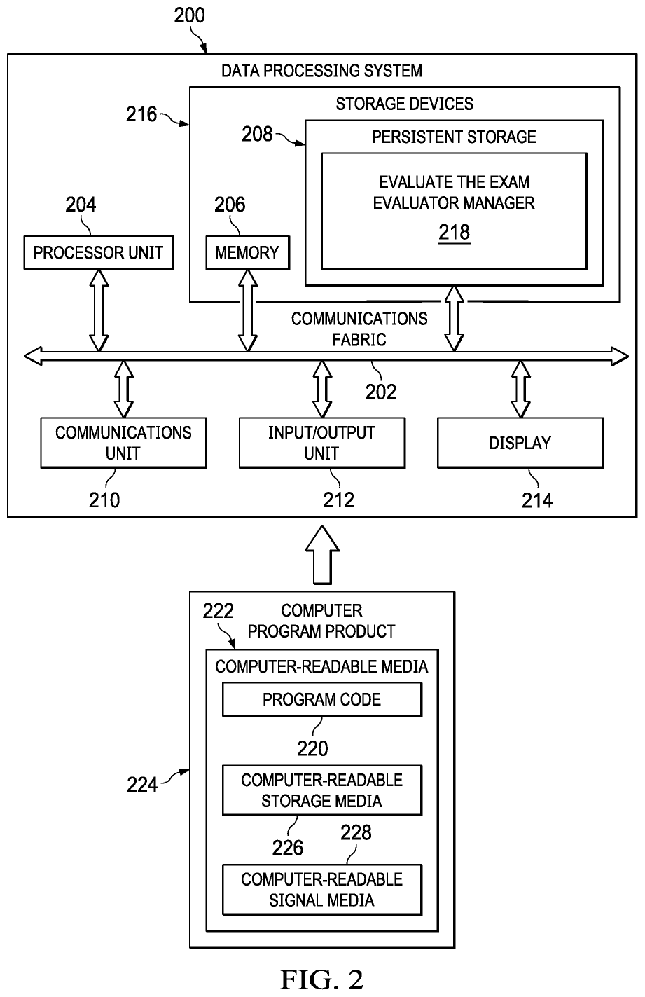

With reference now to FIG. 2, a diagram of a data processing system is depicted in accordance with an illustrative embodiment. Data processing system 200 is an example of a computer, such as server 104 in FIG. 1, in which computer-readable program code or instructions implementing the exam evaluator performance evaluation processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer-readable storage device or a computer-readable storage medium is any piece of hardware that is capable of storing information, such as, for example, without limitation, data, computer-readable program code in functional form, and/or other suitable information either on a transient basis or a persistent basis. Further, a computer-readable storage device or a computer-readable storage medium excludes a propagation medium, such as transitory signals. Furthermore, a computer-readable storage device or a computer-readable storage medium may represent a set of computer-readable storage devices or a set of computer-readable storage media. Memory 206, in these examples, may be, for example, a random-access memory (RAM), or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores evaluate the exam evaluator manager 218. However, it should be noted that even though evaluate the exam evaluator manager 218 is illustrated as residing in persistent storage 208, in an alternative illustrative embodiment evaluate the exam evaluator manager 218 may be a separate component of data processing system 200. For example, evaluate the exam evaluator manager 218 may be a hardware component coupled to communication fabric 202 or a combination of hardware and software components. In another alternative illustrative embodiment, a first set of components of evaluate the exam evaluator manager 218 may be located in data processing system 200 and a second set of components of evaluate the exam evaluator manager 218 may be located in a second data processing system, such as, for example, server 106 in FIG. 1.

Evaluate the exam evaluator manager 218 controls the process of measuring an ability of an exam evaluator to properly evaluate and score answers provided by examinees to questions on examination sheets regarding a particular examination subject. As a result, data processing system 200 operates as a special purpose computer system in which evaluate the exam evaluator manager 218 in data processing system 200 enables exam evaluator performance evaluations. In particular, evaluate the exam evaluator manager 218 transforms data processing system 200 into a special purpose computer system as compared to currently available general computer systems that do not have evaluate the exam evaluator manager 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer-readable program code that may be read and run by a processor in processor unit 204. The program instructions, in the different embodiments, may be embodied on different physical computer-readable storage devices, such as memory 206 or persistent storage 208.

Program code 220 is located in a functional form on computer-readable media 222 that is selectively removable and may be loaded onto or transferred to data processing system 200 for running by processor unit 204. Program code 220 and computer-readable media 222 form computer program product 224. In one example, computer-readable media 222 may be computer-readable storage media 226 or computer-readable signal media 228.

In these illustrative examples, computer-readable storage media 226 is a physical or tangible storage device used to store program code 220 rather than a medium that propagates or transmits program code 220. Computer-readable storage media 226 may include, for example, an optical or magnetic disc that is inserted or placed into a drive or other device that is part of persistent storage 208 for transfer onto a storage device, such as a hard drive, that is part of persistent storage 208. Computer-readable storage media 226 also may take the form of a persistent storage, such as a hard drive, a thumb drive, or a flash memory that is connected to data processing system 200.

Alternatively, program code 220 may be transferred to data processing system 200 using computer-readable signal media 228. Computer-readable signal media 228 may be, for example, a propagated data signal containing program code 220. For example, computer-readable signal media 228 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer-readable media 222” can be singular or plural. For example, program code 220 can be located in computer-readable media 222 in the form of a single storage device or system. In another example, program code 220 can be located in computer-readable media 222 that is distributed in multiple data processing systems. In other words, some instructions in program code 220 can be located in one data processing system while other instructions in program code 220 can be located in one or more other data processing systems. For example, a portion of program code 220 can be located in computer-readable media 222 in a server computer while another portion of program code 220 can be located in computer-readable media 222 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 220.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

An exam evaluator is typically assumed to be correct with regard to examination scoring unless an examinee is able to provide evidence that the exam evaluator was incorrect with regard to scoring one or more answers provided by the examinee. However, proof may be difficult to provide due to the nature of the examination evaluation process. Also, when multiple exam evaluators evaluate and score the same examination sheets comprising questions that require descriptive, explanatory, essay, or narrative type answers, each of these exam evaluators may score answers on the examination sheets differently as the expectations, preferences, and scoring approaches by the exam evaluators may be different, which is natural to some extent. However, this difference in expectations, preferences, and scoring approaches by the exam evaluators may become an issue when the difference is large enough to make an impact on whether an examination score is passing or failing for respective examinees. This is especially true when the examination score is close to the pass/fail boundary. Thus, this type of examination scoring process cannot be considered fair when an examinee fails because one particular exam evaluator scored the examinee's examination sheets and not a different exam evaluator.

Illustrative embodiments determine the expectations, preferences, and scoring approaches of the different exam evaluators by identifying and measuring the differences to determine whether a particular exam evaluator is qualified to score examinations for a particular subject matter. For example, illustrative embodiments identify and measure the difference between a machine scoring approach and an exam evaluator's scoring approach for that particular examination subject matter. Illustrative embodiments also provide feedback to exam evaluators regarding strengths and weaknesses on their respective examination scoring approaches so that respective exam evaluators can work on their weaknesses, while preserving their strengths. Further, illustrative embodiments can automatically adjust examination scores given by a particular exam evaluator by removing identified scoring deviations in the exam evaluator's scoring approach from the machine scoring approach.

Illustrative embodiments generate simulated examination sheets with mock answers, which illustrative embodiments generate based on a set of answer generating factors, such as, for example, completeness of answer, accuracy of answer, and the like. Illustrative embodiments send the simulated examination sheets to an exam evaluator for evaluation and scoring of the mock answers. Illustrative embodiments then assess the exam evaluator's scoring of the mock answers to the questions on the simulated examination sheets. Upon receiving the exam evaluator's scoring of the mock answers, illustrative embodiments compare the exam evaluator's mock answer scores with illustrative embodiments'-generated mock answer scores in order to understand the exam evaluator's scoring approach and to calculate a comparative scoring deviation between the illustrative embodiments' mock answer scoring approach and the exam evaluator's mock answer scoring approach. Illustrative embodiments may utilize the calculated comparative scoring deviation corresponding to the exam evaluator to automatically recalculate an examinee's final examination score to provide a fairer scoring process for the examinee.

Examination evaluation is an important part of learning. In order to achieve quality in examination evaluation of descriptive, explanatory, essay, or narrative type answers, an exam evaluator's scoring of answers needs to be measured against provided model answers on factors of completeness of answer and accuracy of answer. However, it should be noted that alternative illustrative embodiments may utilize other factors as well.

Completeness of answer confirms that an answer to a particular question has all the necessary and relevant constructs, such as, for example, definitions, types, descriptions, examples, advantages, disadvantages, and the like, which makes the descriptive answer complete. It should be noted that there may be missing or/and additional constructs or a haphazard sequence of constructs that impact the length and coverage of an answer. Accuracy of answer confirms that the content provided under the answer constructs is correct in the context of that particular question. In addition to the technical correctness of the content, correctness of language aspects, such as, for example, sentence structure, grammar, spelling, punctuation, and the like, also impact the accuracy of an answer. Further, where evaluation parameters can be configured, such as, for example, identical and repeated mistakes for accuracy of answer, illustrative embodiments can make a one time deduction or multiple deductions in a single answer or an entire examination sheet for an exam evaluator.

For the purpose of simulating the environment for exam evaluators' testing, illustrative embodiments generate new answer versions to questions on the simulated examination sheets. It should be noted illustrative embodiments utilize factors such as completeness of answer and accuracy of answer as answer generating factors for the simulated examination sheets. Illustrative embodiments can assign a set of categories to each answer generating factor. For example, illustrative embodiments can assign categories such as conformance to content structure, identified missing and additional constructs, identified sequence of content constructs, identified length of answer, and the like, for completeness of answer. Similarly, illustrative embodiments can assign categories such as content correctness under each structure, sentence structure, spelling and grammar, repeated mistakes, and the like for accuracy of answer. Of course, illustrative embodiments may enable or disable more or fewer categories under any answer generating factor depending on a particular exam evaluator evaluation process. In other words, illustrative embodiments can enable or disable one or more categories in order to support exam evaluator evaluation in a desired fashion. Furthermore, illustrative embodiments can utilize a set of levels, such as, for example, high, medium, and low levels, for each answer generating factor based on specified percentage values for respective levels corresponding to a particular answer generating factor.

As a result, any answer, either generated or evaluated, will fall under a mix of answer generating factor levels. In other words, in this example 18 overall combinations exist between the 2 answer generating factors of completeness and accuracy and the 3 levels of high, medium, and low for each of the 2 answer generating factors. One combination of answer generating factors and their corresponding levels is known as an answer type herein. For example, answer type 1 may be “HIGH” for completeness and “HIGH” for accuracy, answer type 2 may be “HIGH” for completeness and “MEDIUM” for accuracy, answer type 3 may be “HIGH” for completeness and “LOW” for accuracy, answer type 4 may be “MEDIUM” for completeness and “HIGH” for accuracy, answer type 5 may be “MEDIUM” for completeness and “MEDIUM” for accuracy, answer type 6 may be “MEDIUM” for completeness and “LOW” for accuracy, answer type 7 may be “LOW” for completeness and “HIGH” for accuracy, answer type 8 may be “LOW” for completeness and “MEDIUM” for accuracy, and answer type 9 may be “LOW” for completeness and “LOW” for accuracy. Thus, an answer of answer type 4 will be “MEDIUM” on completeness and “HIGH” on accuracy, for example. An exam administrator may define the combinations for the different answer types. Illustrative embodiments can determine the different answer types based on the defined combinations.

Illustrative embodiments utilize the answer types for both answer generation and answer evaluation. It should be noted that while utilizing answer types for generating multiple answer versions to one question, the answer versions will not be the same due to the broad range that the answer versions cover in respective answer generating factor levels. In addition, illustrative embodiments also utilize target score categories, such as, for example, excellent, very good, average, fair, and poor, for respective answer types. For example, after answer versions are generated and analyzed, illustrative embodiments determine target score categories based on the score awarded to the answer versions. Illustrative embodiments align each respective target score category with one or more answer types. Illustrative embodiments utilize aligned answer types to generate a specified percentage of answers for corresponding target score categories. Illustrative embodiments need the percentage of answers assigned to each target score category to generate the answer versions to the questions on the examination sheets. The percentage of answers assigned to each target score category may limit the number of answer types used for generating the answer versions to the questions on the examination sheets.

Moreover, illustrative embodiments formulate and apply an exam evaluation model for a respective exam evaluator. Illustrative embodiments formulate an exam evaluation model for a particular exam evaluator based on detection of scoring deviations from answer generating factors corresponding to that particular exam evaluator and assigned scores corresponding to answers evaluated by the exam evaluator. To formulate the exam evaluation model, the exam evaluator should evaluate at least 3 (configurable) different answer versions corresponding to one answer type. If 9 answer types are selected for generating answer versions for the examination sheets, then illustrative embodiments need at least 27 answer versions evaluated by the exam evaluator in 3 examination sheets when each examination sheet includes 10 questions or 4 examination sheets when each examination sheet includes 7 questions in order for illustrative embodiments to formulate the exam evaluation model for that particular exam evaluator.

Based on answer scoring provided by the exam evaluator regarding the new answer versions on the simulated examination sheets, illustrative embodiments analyze the scores given by the exam evaluator against scores generated by illustrative embodiments to determine deviations in the scoring. These score deviation patterns formulate the exam evaluation model for that particular exam evaluator, along with scoring correction patterns, which illustrative embodiments can utilize to calculate an evaluation score for that particular exam evaluator.

Thus, illustrative embodiments provide one or more technical solutions that overcome a technical problem with providing a capability of automatically measure an exam evaluator's ability to evaluate and score answers provided by examinees to questions on examination sheets regarding a particular examination subject to increase scoring performance. As a result, these one or more technical solutions provide a technical effect and practical application in the field of exam evaluations.

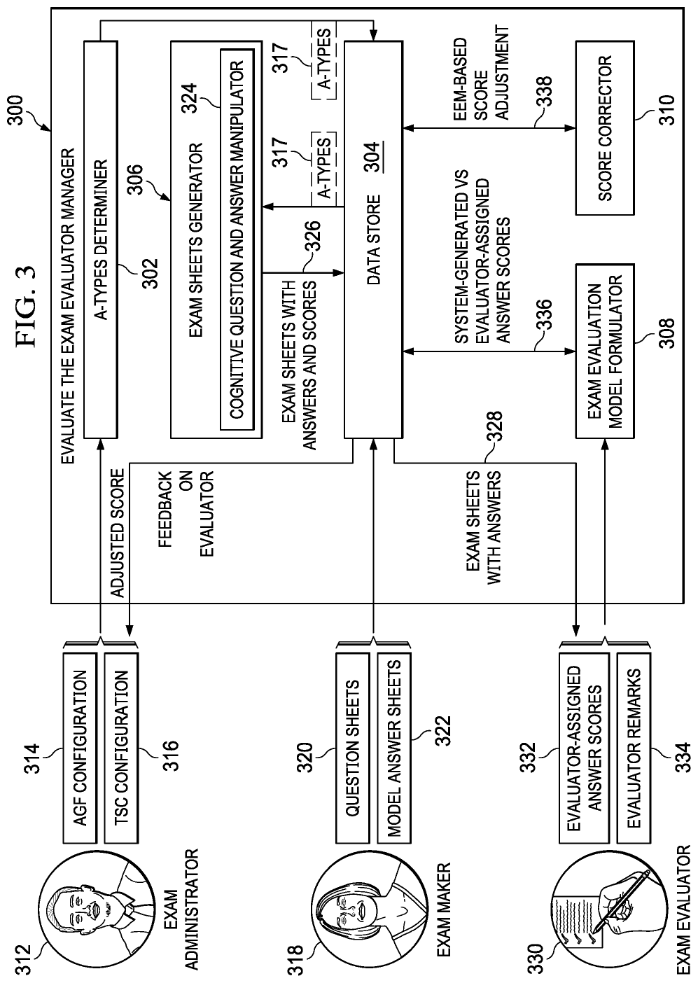

With reference now to FIG. 3, a diagram illustrating an example of an evaluate the exam evaluator manager is depicted in accordance with an illustrative embodiment. Evaluate the exam evaluator manager 300 may be implemented in a computer, such as server 104 in FIG. 1 or a data processing system, such as data processing system 200 in FIG. 2. For example, evaluate the exam evaluator manager 300 may be exam evaluator manager 218 in FIG. 2. Evaluate the exam evaluator manager 300 is comprised of a plurality of components for measuring a particular exam evaluator's ability to evaluate and score answers provided by examinees to questions on examination sheets regarding particular subject matter.

In this example, evaluate the exam evaluator manager 300 includes answer types determiner 302, data store 304, exam sheets generator 306, exam evaluation model formulator 308, and score corrector 310. However, it should be noted that in alternative illustrative embodiments, evaluate the exam evaluator manager 300 may include more or fewer components than shown. For example, a component may be divided into two or more components, two or more components may be combined into one component, a component not shown may be added, or a component may be removed.

Exam administrator 312 inputs answer generating factors (AGF) configuration 314 with a set of corresponding levels and target score categories (TSC) configuration 316 into answer types determiner 302 in order for answer types determiner 302 to select answer types for generating simulated examination sheets with answers regarding a particular examination subject. Objectives of exam administrator 312 may be, for example, to understand score deviation patterns in exam evaluation models and strengths and weaknesses of exam evaluators in order to select a suitable exam evaluator to score examination sheets of a group of examinees for the particular examination subject before an exam evaluator actually score the exam; share feedback with the exam evaluators regarding their exam evaluation model score deviation patterns and strengths and weaknesses in order to train the exam evaluators better for scoring upcoming exams; know the exam evaluation model score deviation patterns of each respective exam evaluator in order to determine whether to adjust final examination scores given by a particular exam evaluator based on the exam evaluation model score deviation patterns of that particular exam evaluator; and the like.

Answer types determiner 302 determines and selects answer types 317 for generating simulated examination sheets with answers for the particular examination subject based on answer generating factors configuration 314 and target score categories configuration 316 input by exam administrator 312 for that particular examination subject. Answer types determiner 302 stores answer types 317 corresponding to answer generating factors configuration 314 and target score categories configuration 316 for the particular examination subject in data store 304.

Exam maker 318 inputs question sheets 320 comprising a plurality of questions corresponding to the particular examination subject, along with model answer sheets 322 corresponding to the plurality of questions into data store 304. With question sheets 320 and model answer sheets 322, exam sheets generator 306 is ready to generate simulated examination sheets with answers to evaluate answer scoring performance of exam evaluators on that particular examination subject.

In response to receiving a request to generate simulated examination sheets for the particular examination subject, exam sheets generator 306 retrieves answer types 317, question sheets 320, and model answer sheets 322 from data store 304. Exam sheets generator 306 generates “x” number of simulated examination sheets. If exam administrator 312 configures 3 answers per answer type and selects 9 answer types overall for simulated examination sheet generation, then exam sheets generator 306 needs to generate at least 27 answers. As a result, x=3 simulated examination sheets if each sheet includes 10 answers to questions or x=4 simulated examination sheets if each sheet includes 7 answers to questions.

Exam sheets generator 306 generates a new answer version of a model answer for a question using the following process. First, exam sheets generator 306 randomly selects an answer type from answer types 317. Second, exam sheets generator 306 randomly selects a question from question sheets 320 in order to generate the new answer version based on the answer generating factor levels assigned to the selected answer type. For example, an answer of answer type 4 from the example above should be “MEDIUM” for completeness of answer and “HIGH” for accuracy of answer. Third, exam sheets generator 306 performs an analysis of the randomly selected question and the corresponding model answer from model answer sheets 322 to detect the constructs and content quality of the corresponding model answer with respect to that randomly selected question using natural language processing. Fourth, based on results of the question and model answer analysis, exam sheets generator 306 selects an appropriate rule set to generate the new answer version. For example, to generate a level of incompleteness in the new answer version, exam sheets generator 306 utilizes cognitive question and answer manipulator 324, which is trained on the particular examination subject, to manipulate the randomly selected question to generate incomplete answer content with lesser constructs in the new answer version using the selected rule set. Cognitive question and answer manipulator 324 may be, for example, an artificial intelligence component with natural language processing capabilities. Similarly, to generate a level of inaccuracy in the new answer version, exam sheets generator utilizes cognitive question and answer manipulator 324 to replace core terms, phrases, sentences, or paragraphs with incorrect terms, phrases, sentences, or paragraphs in the new answer version or completely remove certain terms, phrases, sentences, or paragraphs from the new answer version using the selected rule set. Fifth, exam sheets generator 326 saves in data store 304 the generated new answer version, along with its corresponding answer generating factor levels, based on the manipulation performed by cognitive question and answer manipulator 324 and a baseline score for the generated new answer version calculated by a content scoring process. This ensures that exam sheets generator 306 takes into account the configurations for the answer generating factor levels and target score categories for generating this new answer version and uses the answer generating factor levels and the baseline score to calculate any scoring deviations by an exam evaluator in scoring new answer versions in the simulated examination sheets in a later step. Sixth, after exam sheets generator 306 generates the new answer versions for the plurality of questions in question sheets 320, exam sheets generator 306 can either randomly order questions in simulated examination sheets or order questions to maintain examination sheet level target score categories. At 326, exam sheets generator 306 saves the simulated examination sheets with new answer versions for the particular examination subject and the calculated baseline scores for the new answer versions in data store 304.

At 328, evaluate the exam evaluator manager 300 sends the simulated examination sheets with new answer versions for the particular examination subject to exam evaluator 330 to evaluate and score each of the new answer versions corresponding to the plurality of questions in the simulated examination sheets. It should be noted that exam evaluator 330 represents a set of exam evaluators evaluating and scoring the simulated examination sheets with new answer versions. Also, it is assumed that the set of exam evaluators is aware of examination scoring guidelines and best practices.

After evaluating and scoring the new answer versions in the simulated examination sheets, exam evaluator 330 sends evaluator-assigned answer scores 332 and evaluator remarks 334, which are aligned with the answer generating factor levels, to evaluate the exam evaluator manager 300. Evaluate the exam evaluator manager 300 utilizes exam evaluation model formulator 308 to compare evaluator-assigned answer scores 332 and evaluator remarks 334 with the calculated baseline score for each respective new answer version, which exam evaluation model formulator 308 retrieved from data store 304 at 336. Exam evaluation model formulator 308 calculates any scoring deviations by exam evaluator 330 based on the comparison of the evaluator-assigned scores and the system-generated scores corresponding to the new answer versions. Exam evaluation model formulator 308 generates an exam evaluation model for exam evaluator 330 that includes details of the scoring deviation patterns of exam evaluator 330.

Evaluate the exam evaluator manager 300 sends the exam evaluation model corresponding to exam evaluator 330 to exam administrator 312 for review so that exam administrator 312 can determine whether exam evaluator 330 is qualified to evaluate and score examinations taken by a group of examinees for that particular examination subject in order to maintain high examination scoring quality. Exam administrator 312 can share feedback with exam evaluator 330 regarding answer scoring deviation patterns and strengths and weaknesses in order to train exam evaluator 330 better for evaluating and scoring upcoming examinations.

At 338, score corrector 310 can automatically adjust answer scores given by exam evaluator 330 to questions on an examination taken by a group of examinees for that particular examination subject to form adjusted final answer scores based on the identified scoring deviation patterns in the exam evaluation model corresponding to exam evaluator 330. Score corrector 310 can send the adjusted final answer scores to exam administrator 312 so that exam administrator 312 can make an informed decision regarding whether to publish the adjusted final answer scores or the evaluator-assigned answer scores. Alternatively, score corrector 310 can automatically publish the adjusted final answer scores to the group of examinees.

As a result, illustrative embodiments may be utilized by any type of public or private entities, such as, for example, universities, colleges, schools, training centers, continuing education facilities, and the like, which include learning management systems, assessment management systems, online training and testing platforms, and the like, dealing with the education and training of students, professionals, and the like.

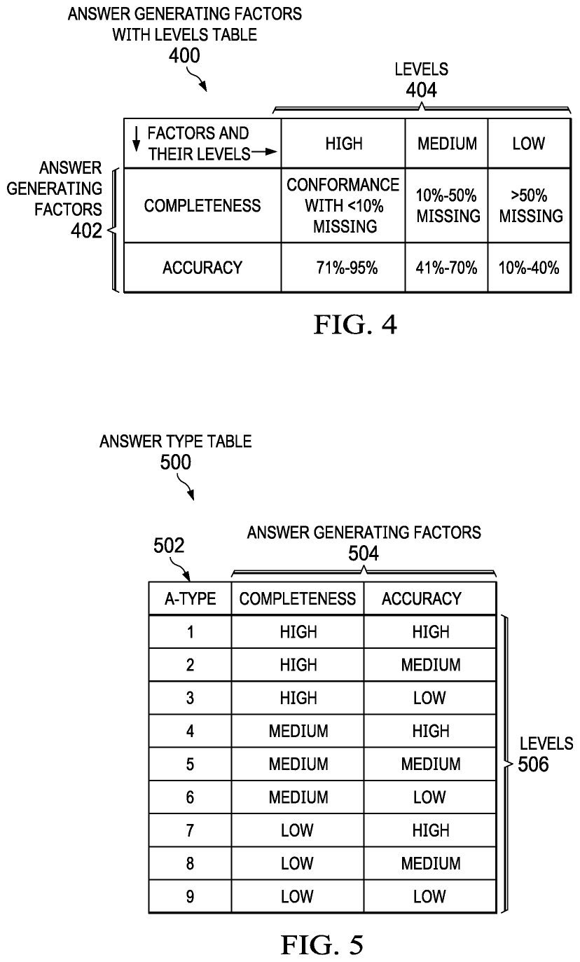

With reference now to FIG. 4, a diagram illustrating an example of a table of answer generating factors with corresponding levels is depicted in accordance with an illustrative embodiment. Answer generating factors with levels table 400 may be implemented in an evaluate the exam evaluator manager, such as, for example, evaluate the exam evaluator manager 218 in FIG. 2 or evaluate the exam evaluator manager 300 in FIG. 3. Answer generating factors with levels table 400 includes answer generating factors 402 and levels 404.

In this example, answer generating factors 402 include completeness of answer and accuracy of answer. Levels 404 include “HIGH”, “MEDIUM”, and “LOW”. A high level for completeness of answer is, for example conformance with less than 10% missing and a high level for accuracy of answer is 71%-95% conformance. A medium level for completeness of answer is, for example, conformance with 10%-50% missing and a medium level for accuracy of answer is 41%-70% conformance. A low level for completeness of answer is, for example, greater than 50% missing and a low level for accuracy of answer is 10%-40% conformance.

However, it should be noted that answer generating factors 402 and levels 404 are meant as examples only and not as limitations of illustrative embodiments. In other words, answer generating factors 402 may include any number and type of answer generating factor and levels 404 may include any number and type of corresponding levels to answer generating factors 402.

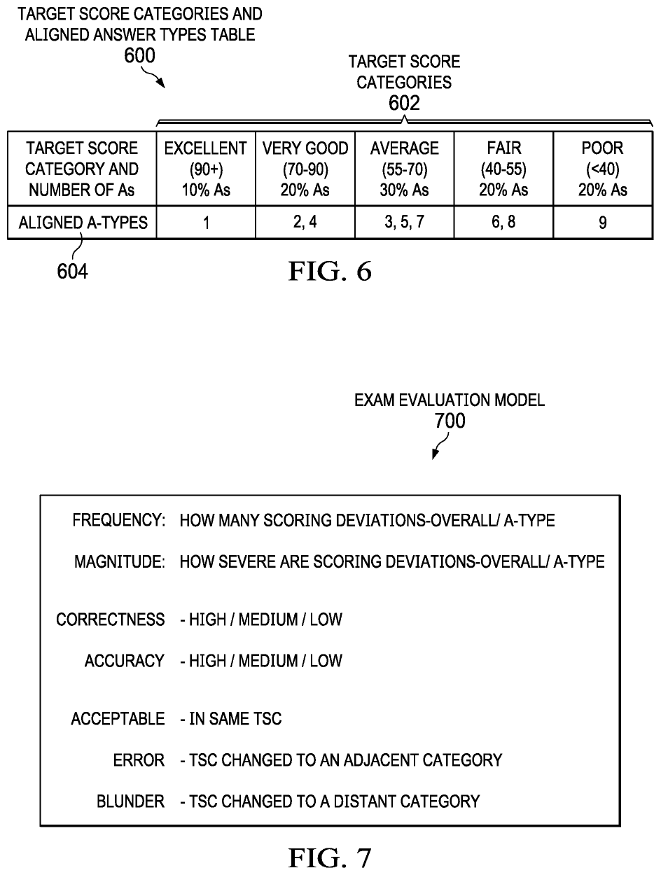

With reference now to FIG. 5, a diagram illustrating an example of a table of answer types is depicted in accordance with an illustrative embodiment. Answer type table 500 may be implemented in may be implemented in an evaluate the exam evaluator manager, such as, for example, evaluate the exam evaluator manager 218 in FIG. 2 or evaluate the exam evaluator manager 300 in FIG. 3. Answer type table 500 includes answer types (A-Type) 502, answer generating factors 504, and levels 506.

In this example, answer types 502 include answer type 1, answer type 2, answer type 3, answer type 4, answer type 5, answer type 6, answer type 7, answer type 8, and answer type 9. However, it should be noted that answer types 502 may include any number of answer types. Answer generating factors 504 may be, for example, answer generating factors 402 in FIG. 4 and include completeness of answer and accuracy of answer. Levels 506 may be, for example, levels 404 in FIG. 4 and include high, medium, and low levels.

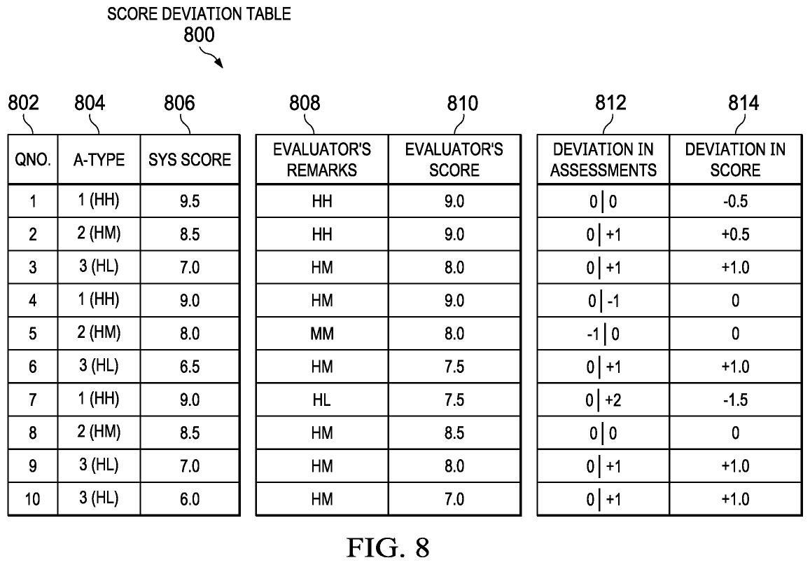

With reference now to FIG. 6, a diagram illustrating an example of a table of target score categories and aligned answer types is depicted in accordance with an illustrative embodiment. Target score categories and aligned answer types table 600 may be implemented in an evaluate the exam evaluator manager, such as, for example, evaluate the exam evaluator manager 218 in FIG. 2 or evaluate the exam evaluator manager 300 in FIG. 3. Target score categories and aligned answer types table 600 includes target score categories 602 and aligned answer types 604.

In this example, target score categories 602 include “EXCELLENT”, “VERY GOOD”, “AVERAGE”, “FAIR”, and “POOR” categories. However, it should be noted that target score categories 602 may include any number and type of target score categories. Aligned answer types 604 include answer types 1-9, such as, for example, answer types 502 in FIG. 5. A target score category of excellent is an answer score greater than 90 and includes 10% of the answers (As) with aligned answer type 1 (e.g., high for completeness of answer and high for accuracy of answer). A target score category of very good is an answer score between 70 and 90 and includes 20% of the answers with aligned answer type 2 (e.g., high for completeness of answer and medium for accuracy of answer) and aligned answer type 4 (e.g., medium for completeness of answer and high for accuracy of answer). A target score category of average is an answer score between 55 and 70 and includes 30% of the answers with aligned answer type 3 (e.g., high for completeness of answer and low for accuracy of answer), aligned answer type 5 (e.g., medium for completeness of answer and medium for accuracy of answer), and aligned answer type 7 (e.g., low for completeness of answer and high for accuracy of answer). A target score category of fair is an answer score between 40 and 55 and includes 20% of the answers with aligned answer type 6 (e.g., medium for completeness of answer and low for accuracy of answer) and aligned answer type 8 (e.g., low for completeness of answer and medium for accuracy of answer). A target score category of poor is an answer score less than 40 and includes 20% of the answers with aligned answer type 9 (e.g., low for completeness of answer and low for accuracy of answer).

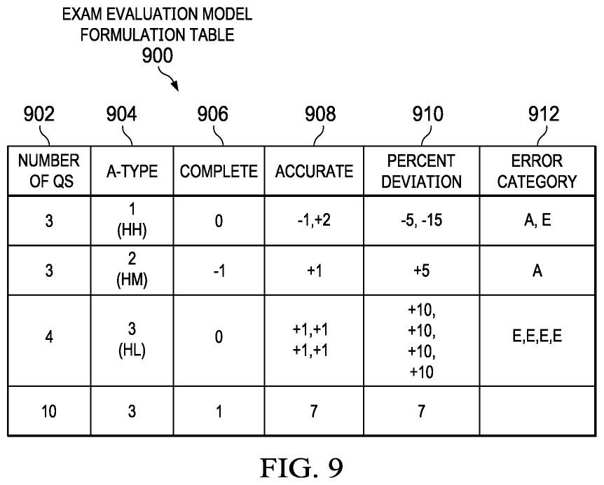

With reference now to FIG. 7, a diagram illustrating an example of an exam evaluation model is depicted in accordance with an illustrative embodiment. Exam evaluation model 700 may be implemented in an evaluate the exam evaluator manager, such as, for example, evaluate the exam evaluator manager 218 in FIG. 2 or evaluate the exam evaluator manager 300 in FIG. 3. Exam evaluation model 700 corresponds to a particular exam evaluator, such as, for example, exam evaluator 330 in FIG. 3. Exam evaluation model 700 provide details of the exam evaluator's scoring deviation patterns.

In this example, exam evaluation model 700 includes a plurality of factors such as frequency, magnitude, correctness, accuracy, acceptable, error, and blunder. However, it should be noted that exam evaluation model 700 may include any number and type of factors. Frequency indicates how many scoring deviations the exam evaluator made overall and for each answer type. Magnitude indicates how severe the scoring deviations where overall and for each answer type. Correctness indicates whether the exam evaluator was high, medium, or low in identifying correctness of answer in the exam evaluator's scoring and remarks. Accuracy indicates whether the exam evaluator was high, medium, or low in identify accuracy of answer in the exam evaluator's scoring and remarks. Acceptable indicates that the exam evaluator's answer scoring was in a same target score category as a correct target score category. Error indicates that the exam evaluator's answer scoring was in an adjacent target score category to the correct target score category. Bunder indicates that the exam evaluator's answer scoring was in a distant target score category from the correct target score category.

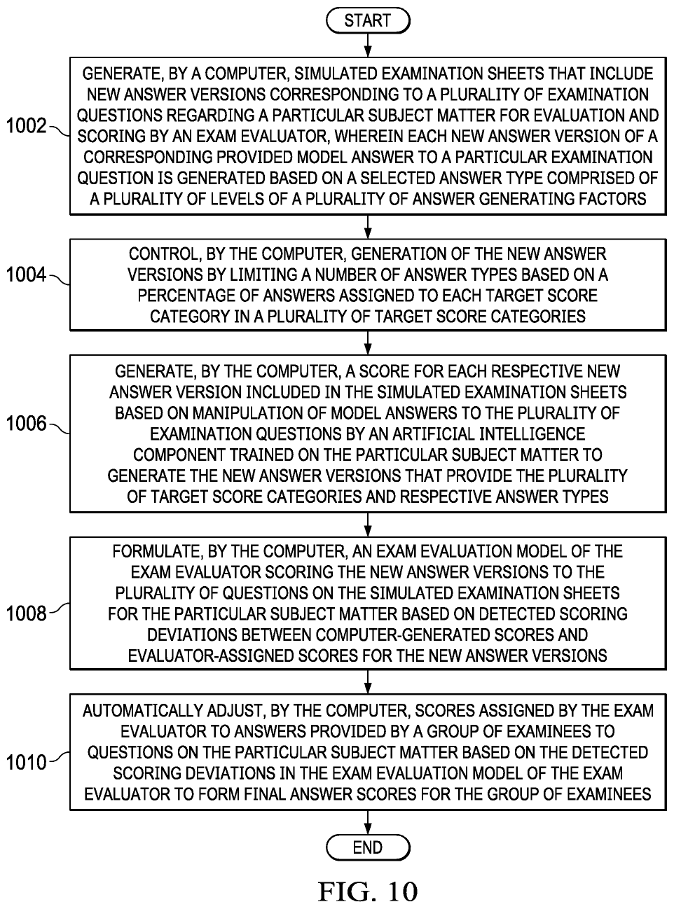

With reference now to FIG. 8, a diagram illustrating an example of a table of score deviations is depicted in accordance with an illustrative embodiment. Score deviation table 800 may be implemented in an evaluate the exam evaluator manager, such as, for example, evaluate the exam evaluator manager 218 in FIG. 2 or evaluate the exam evaluator manager 300 in FIG. 3.

In this example, score deviation table 800 includes question (Q) number 802, answer type 804, system-generated score 806, evaluator's remarks 808, evaluator's assigned score 810, deviation in assessment 812, and deviation in score 814. Question number 802 indicates the number of the question on the simulated examination sheets. Answer type 804 indicates the answer type, such as, for example, answer type 1 with high for completeness and high for accuracy of answer, for the new answer version corresponding that particular question number (e.g., 1). System-generated score 806 indicates the score (e.g., 9.5) calculated by the computer for the new answer version corresponding to that particular question number. Evaluator's remarks 808 indicate whether the exam evaluator's remarks regarding the new answer version (e.g., high (H) for completeness and high (H) for accuracy of answer) coincide with the answer type for that particular question number. Evaluator's assigned score 810 indicates the answer score (e.g., 9.0) given by the exam evaluator for the new answer version corresponding to that particular question number. Deviation in assessment 812 indicates the level of deviation (e.g., 010) between answer type 804 (HH) and evaluator's remarks 808 (HH) for that particular question number. Deviation in score 814 indicates a measure of score deviation (e.g., −0.5) between system-generated score 806 (e.g., 9.5) and evaluator's assigned score 810 (e.g., 9.0) for the new answer version for that particular question number.

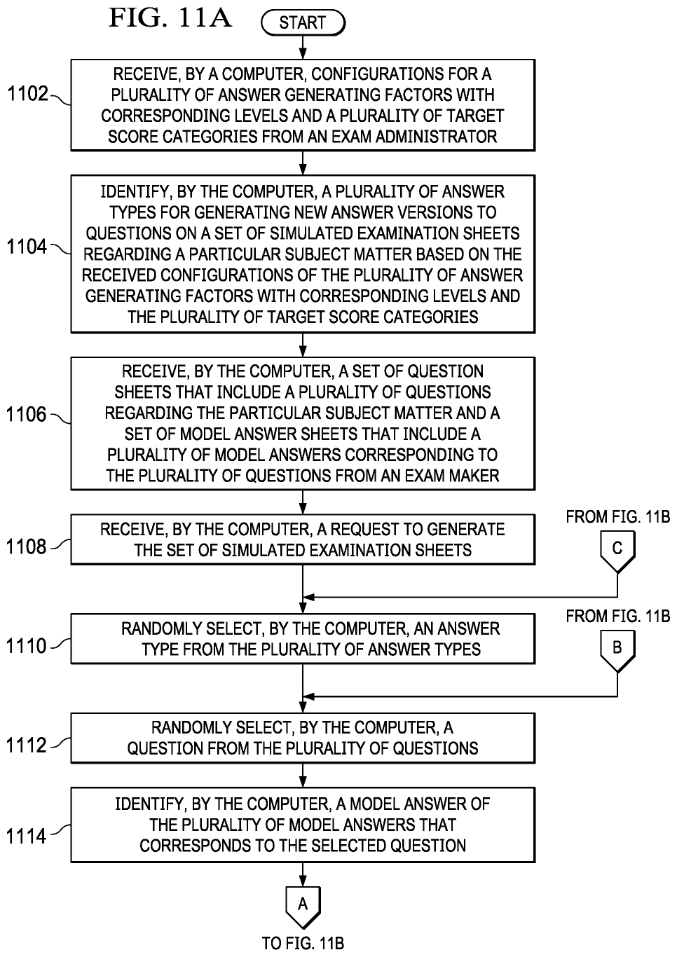

With reference now to FIG. 9, a diagram illustrating an example of a table for exam evaluation model formulation is depicted in accordance with an illustrative embodiment. Exam evaluation model formulation table 900 may be implemented in an evaluate the exam evaluator manager, such as, for example, evaluate the exam evaluator manager 218 in FIG. 2 or evaluate the exam evaluator manager 300 in FIG. 3. The evaluate the exam evaluator manager utilizes the information in a score deviation table, such as, for example, score deviation table 800 in FIG. 8 to generate exam evaluation model formulation table 900. In addition, evaluate the exam evaluator manager utilizes the information in exam evaluation model formulation table 900 to generate an exam evaluation model, such as, for example, exam evaluation model 700 in FIG. 7, for a particular exam evaluator, such as, for example, exam evaluator 330 in FIG. 3. In this example, exam evaluation model formulation table 900 includes number of questions 902, answer types 904, completeness 906, accuracy 908, percentage of deviation 910, and error category 912.

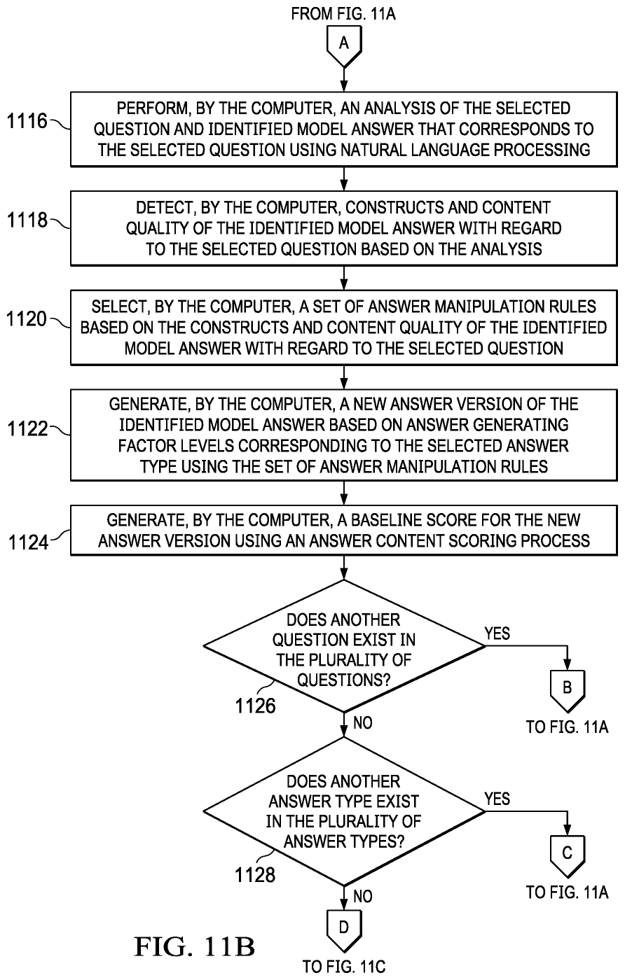

With reference now to FIG. 10, a flowchart illustrating a process for formulating an exam evaluation model corresponding to an exam evaluator is shown in accordance with an illustrative embodiment. The process shown in FIG. 10 may be implemented in a computer, such as, for example, server 104 in FIG. 1 or data processing system 200 in FIG. 2. For example, the process shown in FIG. 10 may be implemented in evaluate the exam evaluator manager 218 in FIG. 2.

The process begins when the computer generates simulated examination sheets that include new answer versions corresponding to a plurality of examination questions regarding a particular subject matter for evaluation and scoring by an exam evaluator (step 1002). Each new answer version of a corresponding provided model answer to a particular examination question is generated based on a selected answer type comprised of a plurality of levels of a plurality of answer generating factors. The computer controls generation of the new answer versions by limiting a number of answer types based on a percentage of answers assigned to each target score category in a plurality of target score categories (step 1004).

The computer generates a score for each respective new answer version included in the simulated examination sheets based on manipulation of model answers to examination questions by an artificial intelligence component of the computer trained on the particular subject matter to generate the new answer versions that provide the plurality of target score categories and respective answer types (step 1006). The computer formulates an exam evaluation model of the exam evaluator scoring the new answer versions to the questions on the simulated examination sheets for the particular subject matter based on detected scoring deviations between computer-generated scores and evaluator-assigned scores for the new answer versions (step 1008). The computer automatically adjusts scores assigned by the exam evaluator to answers provided by a group of examinees to questions on the particular subject matter based on the detected scoring deviations in the exam evaluation model of the exam evaluator to form final answer scores for the group of examinees (step 1010). Thereafter, the process terminates.

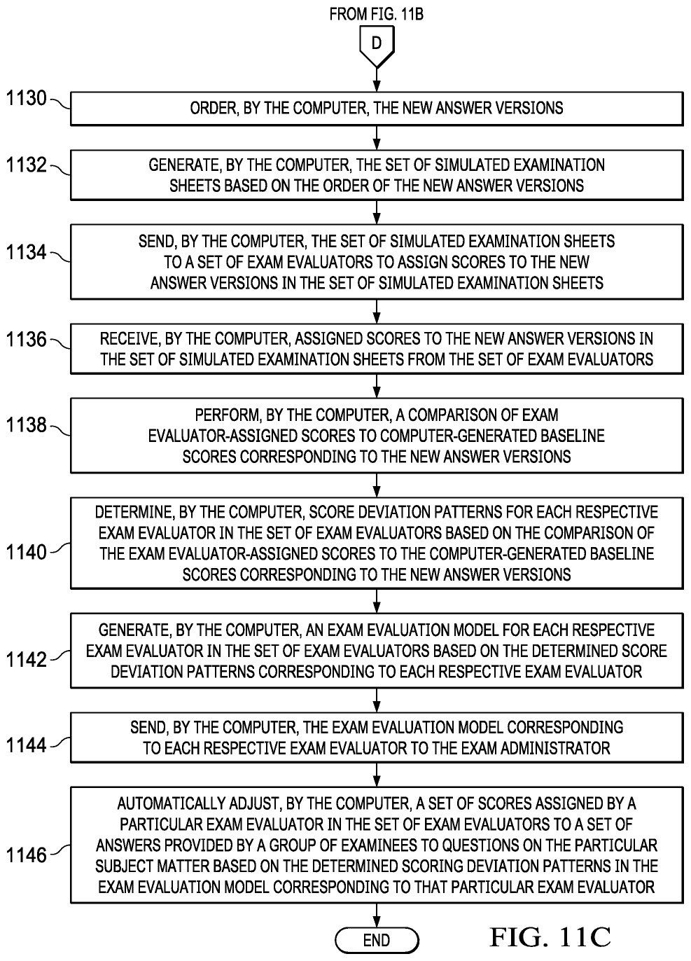

With reference now to FIGS. 11A-11C, a flowchart illustrating a process for evaluating examination scoring performance of an exam evaluator is shown in accordance with an illustrative embodiment. The process shown in FIGS. 11A-11C may be implemented in a computer, such as, for example, server 104 in FIG. 1 or data processing system 200 in FIG. 2. For example, the process shown in FIGS. 11A-11C may be implemented in evaluate the exam evaluator manager 218 in FIG. 2.

The process begins when the computer receives configurations for a plurality of answer generating factors with corresponding levels and a plurality of target score categories from an exam administrator (step 1102). The computer identifies a plurality of answer types for generating new answer versions to questions on a set of simulated examination sheets regarding a particular subject matter based on the received configurations of the plurality of answer generating factors with corresponding levels and the plurality of target score categories (step 1104). In addition, the computer receives a set of question sheets that include a plurality of questions regarding the particular subject matter and a set of model answer sheets that include a plurality of model answers corresponding to the plurality of questions from an exam maker (step 1106).

Subsequently, the computer receives a request to generate the set of simulated examination sheets (step 1108). In response to receiving the request, the computer randomly selects an answer type from the plurality of answer types (step 1110). The computer also randomly selects a question from the plurality of questions (step 1112). Further, the computer identifies a model answer of the plurality of model answers that corresponds to the selected question (step 1114).

Afterward, the computer performs an analysis of the selected question and identified model answer that corresponds to the selected question using natural language processing (step 1116). The computer detects constructs and content quality of the identified model answer with regard to the selected question based on the analysis (step 1118). The computer selects a set of answer manipulation rules based on the constructs and content quality of the identified model answer with regard to the selected question (step 1120).

The computer generates a new answer version of the identified model answer based on answer generating factor levels corresponding to the selected answer type using the set of answer manipulation rules (step 1122). Furthermore, the computer generates a baseline score for the new answer version using an answer content scoring process (step 1124).

The computer makes a determination as to whether another question exists in the plurality of questions (step 1126). If the computer determines that another question does exist in the plurality of questions, yes output of step 1126, then the process returns to step 1112 where the computer randomly selects another question from the plurality of questions. If the computer determines that another question does not exist in the plurality of questions, no output of step 1126, then the computer makes a determination as to whether another answer type exists in the plurality of answer types (step 1128).

If the computer determines that another answer type does exist in the plurality of answer types, yes output of step 1128, then the process returns to step 1110 where the computer randomly selects another answer type from the plurality of answer types. If the computer determines that another answer type does not exist in the plurality of answer types, no output of step 1128, then the computer orders the new answer versions (step 1130).

The computer generates the set of simulated examination sheets based on the order of the new answer versions (step 1132). The computer sends the set of simulated examination sheets to a set of exam evaluators to assign scores to the new answer versions in the set of simulated examination sheets (step 1134). The computer receives assigned scores to the new answer versions in the set of simulated examination sheets from the set of exam evaluators (step 1136).

The computer performs a comparison of exam evaluator-assigned scores to computer-generated baseline scores corresponding to the new answer versions (step 1138). The computer determines score deviation patterns for each respective exam evaluator in the set of exam evaluators based on the comparison of the exam evaluator-assigned scores to the computer-generated baseline scores corresponding to the new answer versions (step 1140). The computer generates an exam evaluation model for each respective exam evaluator in the set of exam evaluators based on the determined score deviation patterns corresponding to each respective exam evaluator (step 1142).

The computer sends the exam evaluation model corresponding to each respective exam evaluator to the exam administrator (step 1144). Moreover, the computer automatically adjusts a set of scores assigned by a particular exam evaluator in the set of exam evaluators to a set of answers provided by a group of examinees to questions on the particular subject matter based on the determined scoring deviation patterns in the exam evaluation model corresponding to that particular exam evaluator (step 1146). Thereafter, the process terminates.

Thus, illustrative embodiments of the present invention provide a computer-implemented method, computer system, and computer program product for measuring an ability of an exam evaluator to evaluate and score answers provided by examinees to questions on examination sheets regarding a particular examination subject. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for evaluating examination scoring performance of exam evaluators, the computer-implemented method comprising:
generating, by a computer, simulated examination sheets that include new answer versions corresponding to a plurality of examination questions regarding a particular subject matter for evaluation and scoring by an exam evaluator, wherein each new answer version of a corresponding provided model answer to a particular examination question is generated based on a selected answer type comprised of a plurality of levels of a plurality of answer generating factors;
generating, by the computer, a score for each respective new answer version included in the simulated examination sheets based on manipulation of model answers to the plurality of examination questions by an artificial intelligence component of the computer trained on the particular subject matter to generate the new answer versions that provide a plurality of target score categories and respective answer types;
formulating, by the computer, an exam evaluation model of the exam evaluator scoring the new answer versions to the plurality of examination questions on the simulated examination sheets for the particular subject matter based on detected scoring deviations between computer-generated scores and evaluator-assigned scores for the new answer versions; and
adjusting, by the computer, scores assigned by the exam evaluator to answers provided by a group of examinees to questions on the particular subject matter based on the detected scoring deviations in the exam evaluation model of the exam evaluator to form final answer scores for the group of examinees.

2. The computer-implemented method of claim 1 further comprising:
controlling, by the computer, generation of the new answer versions by limiting a number of answer types based on a percentage of answers assigned to each target score category in the plurality of target score categories.

3. The computer-implemented method of claim 2 further comprising:
receiving, by the computer, configurations for the plurality of answer generating factors with corresponding levels and the plurality of target score categories from an exam administrator; and
identifying, by the computer, a plurality of answer types for generating the new answer versions to the plurality of examination questions on the simulated examination sheets regarding the particular subject matter based on the configurations of the plurality of answer generating factors with corresponding levels and the plurality of target score categories.

4. The computer-implemented method of claim 1 further comprising:
receiving, by the computer, a set of question sheets that include the plurality of examination questions regarding the particular subject matter and a set of model answer sheets that include a plurality of model answers corresponding to the plurality of examination questions from an exam maker.

5. The computer-implemented method of claim 4 further comprising:
performing, by the computer, an analysis of the plurality of examination questions and the plurality of model answers that corresponds to the plurality of examination questions using natural language processing; and
detecting, by the computer, constructs and content quality of the plurality of model answers with regard to the plurality of examination questions based on the analysis.

6. The computer-implemented method of claim 5 further comprising:
selecting, by the computer, a set of answer manipulation rules based on the constructs and content quality of the plurality of model answers with regard to the plurality of examination questions; and
generating, by the computer, the new answer versions of the plurality of model answers based on answer generating factor levels corresponding to a plurality of answer types using the set of answer manipulation rules.

7. The computer-implemented method of claim 1 further comprising:
generating, by the computer, baseline scores for the new answer versions using an answer content scoring process.

8. The computer-implemented method of claim 1 further comprising:
generating, by the computer, the simulated examination sheets based on an order of the new answer versions;
sending, by the computer, the simulated examination sheets to the exam evaluator to assign scores to the new answer versions in the simulated examination sheets; and
receiving, by the computer, assigned scores to the new answer versions in the simulated examination sheets from the exam evaluator.

9. The computer-implemented method of claim 8 further comprising:
performing, by the computer, a comparison of the evaluator-assigned scores to the computer-generated scores corresponding to the new answer versions;
determining, by the computer, score deviation patterns for the exam evaluator based on the comparison of the evaluator-assigned scores to the computer-generated scores corresponding to the new answer versions; and
generating, by the computer, the exam evaluation model for the exam evaluator based on the score deviation patterns corresponding to the exam evaluator.

10. A computer system for evaluating examination scoring performance of exam evaluators, the computer system comprising:
a bus system;
a storage device connected to the bus system, wherein the storage device stores program instructions; and
a processor connected to the bus system, wherein the processor executes the program instructions to:
generate simulated examination sheets that include new answer versions corresponding to a plurality of examination questions regarding a particular subject matter for evaluation and scoring by an exam evaluator, wherein each new answer version of a corresponding provided model answer to a particular examination question is generated based on a selected answer type comprised of a plurality of levels of a plurality of answer generating factors;
generate a score for each respective new answer version included in the simulated examination sheets based on manipulation of model answers to the plurality of examination questions by an artificial intelligence component of the computer system trained on the particular subject matter to generate the new answer versions that provide a plurality of target score categories and respective answer types;
formulate an exam evaluation model of the exam evaluator scoring the new answer versions to the plurality of examination questions on the simulated examination sheets for the particular subject matter based on detected scoring deviations between computer-generated scores and evaluator-assigned scores for the new answer versions; and
adjust scores assigned by the exam evaluator to answers provided by a group of examinees to questions on the particular subject matter based on the detected scoring deviations in the exam evaluation model of the exam evaluator to form final answer scores for the group of examinees.

11. The computer system of claim 10, wherein the processor further executes the program instructions to:
control generation of the new answer versions by limiting a number of answer types based on a percentage of answers assigned to each target score category in the plurality of target score categories.

12. The computer system of claim 11, wherein the processor further executes the program instructions to:
receive configurations for the plurality of answer generating factors with corresponding levels and the plurality of target score categories from an exam administrator; and
identify a plurality of answer types for generating the new answer versions to the plurality of examination questions on the simulated examination sheets regarding the particular subject matter based on the configurations of the plurality of answer generating factors with corresponding levels and the plurality of target score categories.

13. The computer system of claim 10, wherein the processor further executes the program instructions to:
receive a set of question sheets that include the plurality of examination questions regarding the particular subject matter and a set of model answer sheets that include a plurality of model answers corresponding to the plurality of examination questions from an exam maker.

14. The computer system of claim 13, wherein the processor further executes the program instructions to:
perform an analysis of the plurality of examination questions and the plurality of model answers that corresponds to the plurality of examination questions using natural language processing; and
detect constructs and content quality of the plurality of model answers with regard to the plurality of examination questions based on the analysis.

15. A computer program product for evaluating examination scoring performance of exam evaluators, the computer program product comprising a computer-readable storage medium having program instructions embodied therewith, the program instructions executable by a computer to cause the computer to perform a method of:
generating, by the computer, simulated examination sheets that include new answer versions corresponding to a plurality of examination questions regarding a particular subject matter for evaluation and scoring by an exam evaluator, wherein each new answer version of a corresponding provided model answer to a particular examination question is generated based on a selected answer type comprised of a plurality of levels of a plurality of answer generating factors;
generating, by the computer, a score for each respective new answer version included in the simulated examination sheets based on manipulation of model answers to the plurality of examination questions by an artificial intelligence component of the computer trained on the particular subject matter to generate the new answer versions that provide a plurality of target score categories and respective answer types;
formulating, by the computer, an exam evaluation model of the exam evaluator scoring the new answer versions to the plurality of examination questions on the simulated examination sheets for the particular subject matter based on detected scoring deviations between computer-generated scores and evaluator-assigned scores for the new answer versions; and
adjusting, by the computer, scores assigned by the exam evaluator to answers provided by a group of examinees to questions on the particular subject matter based on the detected scoring deviations in the exam evaluation model of the exam evaluator to form final answer scores for the group of examinees.

16. The computer program product of claim 15 further comprising:
controlling, by the computer, generation of the new answer versions by limiting a number of answer types based on a percentage of answers assigned to each target score category in the plurality of target score categories.

17. The computer program product of claim 16 further comprising:
receiving, by the computer, configurations for the plurality of answer generating factors with corresponding levels and the plurality of target score categories from an exam administrator; and
identifying, by the computer, a plurality of answer types for generating the new answer versions to the plurality of examination questions on the simulated examination sheets regarding the particular subject matter based on the configurations of the plurality of answer generating factors with corresponding levels and the plurality of target score categories.

18. The computer program product of claim 15 further comprising:
receiving, by the computer, a set of question sheets that include the plurality of examination questions regarding the particular subject matter and a set of model answer sheets that include a plurality of model answers corresponding to the plurality of examination questions from an exam maker.

19. The computer program product of claim 18 further comprising:
performing, by the computer, an analysis of the plurality of examination questions and the plurality of model answers that corresponds to the plurality of examination questions using natural language processing; and
detecting, by the computer, constructs and content quality of the plurality of model answers with regard to the plurality of examination questions based on the analysis.

20. The computer program product of claim 19 further comprising:
selecting, by the computer, a set of answer manipulation rules based on the constructs and content quality of the plurality of model answers with regard to the plurality of examination questions; and
generating, by the computer, the new answer versions of the plurality of model answers based on answer generating factor levels corresponding to a plurality of answer types using the set of answer manipulation rules.
